(19) United States
(12) Patent Application Publication
(10) Pub. No.: US 2009/0163760 A1
(43) Pub. Date: Jun. 25, 2009

(54) Method of Reducing Cadmium and Lead in Hazardous Waste From a Foundry or Steel Mill Using Micronized Particulate Reactive Magnesium Oxide or Magnesium Hydroxide Having High Surface Area

(76) Inventor: Robert Stanforth, Madison, WI (US)

Correspondence Address: QUARLES & BRADY LLP, 33 E. MAIN ST, SUITE 900, P.O BOX 2113, MADISON, WI, 53701-2113, US

(21) Appl. No.: 12/338,330

(22) Filed: Dec. 18, 2008

Related U.S. Application Data
(60) Provisional application No. 61/016,181, filed on Dec. 21, 2007.

(51) Int. Cl. A62D 3/36; A62D 101/08

(52) U.S. Cl. 588/318

(57) ABSTRACT

Methods of using micronized particulate, reactive magnesium oxide or magnesium hydroxide to treat hazardous waste having high zinc content and hazardous levels of cadmium and lead. The reactive magnesium oxide or magnesium hydroxide has a median particle size in the range of 2-3 μm. The hazardous waste material is generated by a foundry or steel mill.

### CROSS REFERENCE TO RELATED APPLICATIONS

This application claims priority to and benefit of U.S. Provisional Patent Application Ser. No. 61/016,181 filed Dec. 21, 2007, which is hereby incorporated herein by reference in its entirety.

### BACKGROUND OF THE INVENTION

Some iron foundry wastes are classified as hazardous due to the leached concentrations of cadmium (Cd) and/or lead (Pb). Such classification is in accordance with the U.S. Environmental Protection Agency's (USEPA) Toxicity Characteristics Leaching Procedure (TCLP, SW-846 Method 1311) test for classifying waste as hazardous. Various approaches have been developed to treat such hazardous wastes in order to render them nonhazardous.

In one approach, orthophosphates and pH control agents have been used to treat Cd and Pb containing hazardous waste. Specifically, Triple Super Phosphate (TSP) has been used as the phosphate source, and ordinary magnesium phosphate (MgO) or magnesium hydroxide (Mg(OH)₂) has been used to control pH. That combination has been an effective treatment methodology for many years. One reason for its success over approaches using more alkaline pH control agents is that MgO or Mg(OH)₂ is an effective buffer that prevents the pH for raising to the point where Pb solubilizes as an anionic complex.

However, the TSP/MgO/Mg(OH)₂ combination is not every effective at treating some more recent foundry wastes. Even at very high dosing, the TSP/MgO/Mg(OH)₂ combination fails to effectively treat some Cd and Pb containing foundry wastes. In particular, foundry Cd and Pb foundry wastes that contain high concentrations of zinc (Zn) cannot be effectively treated with the TSP/MgO/Mg(OH)₂ combination or TSP alone. For some reason, the high Zn concentrations prevent metals from being immobilized (i.e., the metals remain or become solubilized), particularly Cd.

The presence of Zn-galvanized materials in scrap metal has been increasing and continues to increase. The USEPA has estimated that 98% of the Zn present in scrap metal volatilized during the melting operation is captured by air pollution control systems. However, recently, some foundries are having difficulty effectively treating air pollution control dusts and sludges that contain high concentrations of Zn. Very high doses of treatment additives (such as 20 wt % or more) is needed, which is very costly.

Some foundries are also incurring higher disposal costs due to ineffective or marginally effective treatment of metal-containing hazardous waste. Inconsistent and ineffective treatment also causes operation interruptions, which are also very costly. Thus, improved approaches and chemical treatments are needed to more effectively remove metals such as Cd and Pb from hazardous foundry wastes containing high concentrations of Zn.

### SUMMARY OF THE INVENTION

One aspect of the invention is a method of treating a waste material comprising the acts or steps of contacting the waste material with an effective amount of micronized particulate reactive magnesium oxide (MgO), magnesium hydroxide Mg(OH)₂ or a combination thereof, each having a median particle size in the range of 2-3 μm. As used herein, “reactive” magnesium oxide or magnesium hydroxide means such micronized particulate material having a median particle size in the range of 2-3 μm.

In an exemplary embodiment of the method of treating a waste material, the waste material is hazardous waste containing one or more metals being Cd, Pb and Zn.

In another exemplary embodiment of the method of treating a waste material, the waste material is generated by a foundry or steel mill.

In another exemplary embodiment of the method of treating a waste material, the hazardous waste comprises 7.4-920 mg/kg Cd, 14-22,000 mg/kg Pb and 1200-290,000 mg/kg Zn.

In another exemplary embodiment of the method of treating a waste material, the hazardous waste comprises 7.4-15 mg/kg Cd, 14-71 mg/kg Pb and 1200-1700 mg/kg Zn.

In another exemplary embodiment of the method of treating a waste material, the hazardous waste comprises 490-920 mg/kg Cd, 13,000-22,000 mg/kg Pb and 170,000-290,000 mg/kg Zn.

In another exemplary embodiment of the method of treating a waste material, the magnesium oxide or magnesium hydroxide is made by precipitation in situ from a magnesium-rich solution, such as sea water or brine. Preferably, the precipitated MgO and/or Mg(OH)₂ is substantially amorphous.

In another exemplary embodiment of the method of treating a waste material, the effective amount is in the range of 1 wt % to 15 wt %.

In another exemplary embodiment of the method of treating a waste material, the effective amount is in the range of 8 wt % to 10 wt %.

In another exemplary embodiment of the method of treating a waste material, the effective amount is in the range of 7.5 wt % to 10 wt %.

In another exemplary embodiment of the method of treating a waste material, the effective amount is in the range of 5 wt % to 15 wt %.

In another exemplary embodiment of the method of treating a waste material, the effective amount is in the range of 5 wt % to 12.5 wt %.

In another exemplary embodiment of the method of treating a waste material, the effective amount is in the range of 5 wt % to 7.5 wt %.

In another exemplary embodiment of the method of treating a waste material, the pH of the TCLP test leachate from the treated waste is in the range of 6.63-10.06.

In another exemplary embodiment of the method of treating a waste material, the pH of the TCLP test leachate from the treated waste is in the range of 7.39-9.88.

In another exemplary embodiment of the method of treating a waste material, the pH of the TCLP test leachate from the treated waste is in the range of 8.48-9.69.

In another exemplary embodiment of the method of treating a waste material, the Zn content of the waste material is at least 10 wt %.

In another exemplary embodiment of the method of treating a waste material, the hazardous waste is treated by injecting micronized particulate magnesium oxide into ducts within the foundry or steel mill.

In another exemplary embodiment of the method of treating a waste material, the method further comprises the step or act of contacting the waste material with an effective amount of triple super phosphate.

In another exemplary embodiment of the method of treating a waste material, the steel mill or foundry has an in-line treatment system, and the micronized particulate magnesium oxide is administered by the in-line treatment system.

In another exemplary embodiment of the method of treating a waste material, the hazardous waste material is rendered non-hazardous.

### BRIEF DESCRIPTION OF THE DRAWINGS

Not applicable.

### DETAILED DESCRIPTION OF THE EXEMPLARY EMBODIMENTS

Without being bound to any specific theory, it is postulated that the high ZnO content substantially prevents the ordinary mined MgO from raising the pH of the hazardous waste material. As used herein, “ordinary” or “nonreactive” magnesium oxide or magnesium hydroxide means such materials that have a median particle size materially larger than the range of 2-3 μm. In other words, such materials are more coarse having a materially larger particle size and materially less surface area in terms of reactivity with zinc compounds such as ZnO. Ordinary MgO is less reactive towards the TCLP test acids as compared to the ZnO. ZnO quickly reacts with the leaching acid forming zinc ion (Zn²⁺), which then reprecipitates as zinc hydroxide as the pH increases due to the presence of the MgO and coats (or otherwise agglomerates therewith) the ordinary MgO rendering the MgO ineffective and nonreactive.

ZnO in the waste material also reacts with the leaching acids in the TCLP test before and faster than ordinary MgO, which results in high dissolved zinc concentrations. Then, the dissolved zinc precipitates as zinc hydroxide as the pH of the TCLP test solution increases. Ordinary MgO reacts much more slowly than the ZnO, but it slowly raises the pH after the ZnO is dissolved.

As the pH increases, zinc becomes supersaturated and precipitates as the hydroxide. The newly formed zinc hydroxide coats/agglomerates the hazardous metal solids in the waste, which prevents the ordinary MgO or other treatment chemicals/reagents from reacting with the hazardous metal solids. TSP particles may also be coated by the zinc hydroxide precipitate, which prevents the TSP from treating the hazardous metal particles.

Thus, the rapid reaction of the ZnO with the leaching acid in the TCLP test and the subsequent precipitation of the zinc hydroxide prevents effective treatment of hazardous waste materials from foundries and steel mills having high zinc content. Treatment doses up to 25% and higher may be needed to effectively treat such hazardous wastes, but still with inconsistent results.

In contrast, the highly reactive, micronized particulate magnesium oxide and magnesium hydroxide of the instant invention effectively treats metal-containing hazardous waste by controlling the pH in the leaching test (or in the environment) to a range where most hazardous metals are insoluble or substantially insoluble. As such, reactive micronized particulates have wide use and applicability.

The reactive micronized particulates also treat a wide variety of hazardous wastes without much need for adjustment and monitoring. Thus, cost savings result from this sort of effective treatment because it does not require high doses, significant monitors, controls and/or testing.

### EXAMPLES

The comparative data shown in Table 1 demonstrates the unexpected superiority of reactive MgO as compared to nonreactive MgO. The hazardous waste materials shown in Table 1 are those generated at various foundries and steel mills. These facilities generate around 25,000 tons per year of metal containing hazardous waste.

TABLE 1
Demonstration of Reactive MgO Effectiveness

| | | | | | |
|---|---|---|---|---|---|
| | Wt. % of | | Cd¹ | | Zn³ |
| Treatment | treatment | pH | (mg/L) | Pb² (mg/L) | (mg/L) |

Sample 1, TCLP Results

| | | | | | |
|---|---|---|---|---|---|
| No treatment | 0 | 4.92 | 7.4 | 27 | 1200 |
| Cement waste + | 35 | 6.54 | 2.2 | 1.6 | 380 |
| TSP | 40 | 5.66 | 1.6 | 0.24 | 300 |
| | 50 | 6.78 | 1.3 | 0.74 | 230 |
| Nonreactive MgO | 15 | 7.64 | 5.3 | 20 | 90 |
| | 20 | 7.98 | 3.2 | 14 | 16 |
| | 25 | 8.47 | 0.58 | 0.27 | 0.66 |
| | 30* | 9.23* | 0.11* | 0.058* | 0.039* |
| Reactive MgO | 6 | 8.48 | 1.2 | 6.5 | 1.9 |
| | 8* | 9.58* | 0.038* | 0.86* | 0.044* |
| | 10* | 9.88* | 0.016* | 3.5* | 0.038* |

Sample 2, TCLP Results

| | | | | | |
|---|---|---|---|---|---|
| No treatment | 0% | 6.29 | 12 | 71 | 1400 |
| Cement Waste + | 10% | 6.86 | 11 | 69 | 970 |
| TSP | 15% | 7.30 | 9.0 | 33 | 320 |
| | 20% | 8.44 | 2.3 | 0.65 | 3.3 |
| Reactive MgO | 5 | 8.71 | 0.96 | 0.18 | 1.7 |
| | 7.5* | 9.59* | 0.048* | <0.04* | 0.08* |
| | 10* | 9.69* | 0.041* | <0.04* | 0.64* |

Sample 3, TCLP Results

| | | | | | |
|---|---|---|---|---|---|
| No treatment | 0 | 6.29 | 12 | 14 | 1700 |
| Cement waste + | 10 | 6.73 | 9.7 | 1.6 | 1000 |
| TSP | 15 | 6.65 | 7.1 | 0.62 | 810 |
| | 20 | 6.77 | 6.3 | 0.45 | 670 |
| Nonreactive MgO | 12.5 | 7.01 | 8.3 | 1.9 | 590 |
| | 15 | 7.10 | 7.6 | 1.5 | 470 |
| | 20 | 7.34 | 6.7 | 0.94 | 220 |
| Reactive MgO | 5 | 7.39 | 6.4 | 1.9 | 160 |
| | 6 | 9.3 | 0.12 | <0.013 | 0.018 |
| | 7* | 9.58* | 0.039* | <0.013* | 0.011* |
| | 8* | 9.69* | 0.028* | <0.013* | 0.015* |

*Successful treatment
¹Treatment criteria being 1.0/0.11 mg/L for Hazardous waste/UTS
²Treatment criteria being 5.0/0.75 mg/L for Hazardous waste/UTS
³Treatment criteria being none/4.3 mg/L for Hazardous waste/UTS

The data shown in Table 2 below demonstrates the use of reactive MgO having a median particle size of 2 μm. The reactive MgO was made by precipitation from a magnesium rich brine. Ordinary MgO used for treating foundry wastes is mined and has a surface area of 80 μm. The precipitated MgO is significantly more reactive and provides unexpectedly superior treatment of metal-containing hazardous waste. Doses of 5 wt % can effectively treat some metal-containing hazardous waste.

For example, a 1 wt % dose of reactive MgO provides a Mg concentration of 300 mg/L in the TCLP test if all the MgO dissolves. The observed concentration of 340 mg/L indicates that all the added MgO dissolved. That amount of reactive MgO neutralizes 0.015 M H⁺ or 15% of the acid present in the TCLP test. The other 85% remains to be neutralized by the Zn in the waste.

A 6 wt % dose of MgO provides sufficient neutralizing capacity to neutralize essentially all of the acid in the TCLP test leaving none remaining for the Zn (in the waste) to neutralize. The relatively low concentration of Zn in the 6% MgO sample (0.038 mg/L) indicated that the Zn was not neutralizing any of the acid in the TCLP test.

TABLE 2

| Treatment | TCLP Test Results | | | | |
|---|---|---|---|---|---|
| (wt % Reactive MgO) | pH | Cd | Mg | Pb | Zn |
| Untreated | 6.29 | 15 | 200 | 30 | 1700 |
| 1 | 6.63 | 9.5 | 340 | 18 | 760 |
| 2.5 | 7.38 | 6.7 | 660 | 2.4 | 72 |
| 5 | 9.6 | 0.026 | 730 | <0.013 | 0.067 |
| 6 | 9.23 | 0.29 | 1100 | <0.03 | 0.038 |
| | 9.23 | 0.35 | 1100 | <0.13 | 0.0077 |
| 7 | 9.56 | 0.074 | 1200 | <0.13 | 0.018 |
| | 9.58 | 0.079 | 1200 | <0.13 | 0.018 |
| 7.5 | 9.64 | 0.057 | — | <0.13 | 0.017 |
| 8 | 9.67 | 0.050 | 1200 | <0.13 | 0.014 |
| | 9.7 | 0.046 | 1200 | <0.13 | 0.017 |
| 10 | 9.76 | 0.033 | — | <0.13 | 0.012 |
| 12.5 | 9.85 | 0.020 | — | <0.13 | 0.014 |

As shown in Table 3 below, the data includes two examples of high Zn containing wastes that were ineffectively treated using ordinary MgO but were effectively treated with reactive MgO, whereby the results were also unexpectedly superior and synergistic as compared to the ordinary MgO. Sample 4 also provides an example where the waste leached significant concentrations of Cd, Pb and Zn in a water test.

The data demonstrates that addition of the reactive MgO reduced the leaching of Cd, Pb, and Zn to very low values. In contrast, the addition of Ca(OH)₂ to waste in the water test raises the pH to the point where Pb is resolubilized. Addition of as little as 2.5% Ca(OH)₂ raised the pH in a water leaching test to such alkaline levels that Pb was resolubilized at over the hazardous waste criterion of 5 mg/L. Overdosing of Ca(OH)₂ in a TCLP test can also result in Pb being resolubilized as the pH rises to very alkaline values. Reactive MgO is vastly superior to Ca(OH)₂ in that regard.

TABLE 3

| | TCLP Test Results | | | | |
|---|---|---|---|---|---|
| Treatment (wt %) | pH | Cd | Mg | Pb | Zn |

Sample 3

| | | | | | |
|---|---|---|---|---|---|
| Untreated | 6.12 | 7.4 | — | 15.4 | 1890 |
| | 6.05 | 7.84 | — | 18.7 | 1810 |
| 5% ordinary MgO | 6.92 | 7.8 | 300 | 4.1 | 730 |
| 10% ordinary MgO | 7.11 | 4.9 | 440 | 2.1 | 360 |
| 15% ordinary MgO | 7.44 | 3.9 | 550 | 0.87 | 89 |
| 20% ordinary MgO | 8.50 | 0.38 | 590 | 0.014 | 0.33 |
| 5% Reactive MgO | 9.75 | 0.0093 | — | <0.013 | 0.017 |
| 7.5% Reactive MgO | 9.76 | <0.0063 | — | 0.013 | 0.010 |

Sample 4
TCLP Tests

| | | | | | |
|---|---|---|---|---|---|
| Untreated | 6.29 | 12 | — | 71 | 1400 |
| | 6.86 | 11 | — | 69 | 970 |
| 5% ordinary MgO | 6.84 | 11 | 290 | 55 | 1100 |
| 7.5% ordinary MgO | 6.94 | 11 | 490 | 43 | 700 |
| 10% ordinary MgO | 6.98 | 9.7 | 460 | 37 | 600 |
| 15% ordinary MgO | 7.16 | 9.20 | 550 | 23 | 300 |
| 25% ordinary MgO | 8.38 | 1.1 | 650 | 0.056 | 0.87 |
| 2.5% Reactive MgO | 6.74 | 10 | 590 | 70 | 1100 |
| 5% Reactive MgO | 8.71 | 0.96 | 1100 | 0.18 | 1.7 |
| 7.5% Reactive MgO | 9.59 | 0.048 | 1200 | <0.04 | 0.08 |
| 10% Reactive MgO | 9.69 | 0.041 | 1300 | <0.04 | 0.64 |
| 12.5% Reactive MgO | 9.94 | 0.013 | 1200 | <0.04 | 0.15 |
| 15% Reactive MgO | 10.06 | 0.0074 | 1200 | <0.04 | 0.13 |

EP Water Tests

| | | | | | |
|---|---|---|---|---|---|
| Untreated (water test) | 6.54 | 11.2 | — | 2.57 | 223 |
| | 6.61 | 11.2 | — | 2.71 | 228 |
| 10% Reactive MgO | 10.45 | <0.0019 | 110 | <0.04 | 0.042 |
| 12.5% Reactive MgO | 10.55 | <0.0019 | 110 | <0.04 | 0.056 |
| 15% Reactive MgO | 10.52 | <0.0019 | 100 | <0.04 | 0.031 |

Sample 3 had an initial composition of 490 mg/kg Cd, 6900 mg/kg Mg, 13,000 mg/kg Pb, and 170,000 mg/kg Zn.
Sample 4 had an initial composition of 920 mg/kg Cd, 19,000 mg/kg Mg, 22,000 mg/kg Pb, and 290,000 mg/kg Zn.

We claim:

1. A method of treating a waste material comprising contacting the waste material with an effective amount of particulate magnesium oxide, magnesium hydroxide or a combination thereof each having a median particle size in the range of 2-3 μm.

2. The method of claim 1, comprising the magnesium oxide.

3. The method of claim 2, wherein the waste material is hazardous waste containing one or more metals selected from the group consisting of Cd, Pb and Zn.

4. The method of claim 3, wherein the waste material is generated by a foundry or steel mill.

5. The method of claim 4, wherein the hazardous waste comprises 7.4-920 mg/kg Cd, 14-22,000 mg/kg Pb and 1200-290,000 mg/kg Zn.

6. The method of claim 4, wherein the hazardous waste comprises 7.4-15 mg/kg Cd, 14-71 mg/kg Pb and 1200-1700 mg/kg Zn.

7. The method of claim 4, wherein the hazardous waste comprises 490-920 mg/kg Cd, 13,000-22,000 mg/kg Pb and 170,000-290,000 mg/kg Zn.

8. The method of claim 1, wherein the magnesium oxide or magnesium hydroxide is made by in situ precipitation from a magnesium-rich brine or sea water.

9. The method of any one of claims 4-7, wherein the effective amount is in the range of 1 wt % to 15 wt %.

10. The method of any one of claims 4-7, wherein the effective amount is in the range of 8 wt % to 10 wt %.

11. The method of any one of claims 4-7, wherein the effective amount is in the range of 7.5 wt % to 10 wt %.

12. The method of any one of claims 4-7, wherein the effective amount is in the range of 5 wt % to 15 wt %.

13. The method of any one of claims 4-7, wherein the effective amount is in the range of 5 wt % to 12.5 wt %.

14. The method of any one of claims 4-7, wherein the effective amount is in the range of 5 wt % to 7.5 wt %.

15. The method of any one of claims 4-7, wherein the pH of the treated waste is in the range of 6.63-10.06.

16. The method of any one of claims 4-7, wherein the pH of the treated waste is in the range of 7.39-9.88.

17. The method of any one of claims 4-7, wherein the pH of the treated waste is in the range of 8.48-9.69.

18. The method of claim 3, wherein the Zn content is at least 10 wt %.

19. The method of claim 2, wherein the magnesium oxide is substantially amorphous.

20. The method of claim 1, comprising the magnesium hydroxide, wherein the magnesium hydroxide is substantially amorphous.

21. The method of claim 4, wherein the hazardous waste is treated by injecting particulate magnesium oxide into ducts within the foundry or steel mill.

22. The method of claim 1, further comprising contacting the waste material with an effective amount of triple super phosphate.

23. The method of claim 4, wherein the steel mill or foundry has an in-line treatment system, and wherein the particulate magnesium oxide is administered by the in-line treatment system.

24. The method of claim 10, wherein the hazardous waste material is rendered non-hazardous.

25. The method of claim 11, wherein the hazardous waste material is rendered non-hazardous.
